(19) United States
(12) Patent Application Publication
(10) Pub. No.: US 2023/0416899 A1
(43) Pub. Date: Dec. 28, 2023

(54) CHROMIUM(VI)-FREE SLIP FOR DIFFUSION COATING

(71) Applicant: M-M-MORANT-GMBH, Bernau (DE)

(72) Inventors: Alexander RUHL, Bernau (DE); Max MORDANT, Bernau (DE)

(73) Assignee: M-M-MORANT-GMBH, Bernau (DE)

(21) Appl. No.: 18/036,897

(22) PCT Filed: Nov. 4, 2021
(86) PCT No.: PCT/EP2021/080581

§ 371 Date: May 15, 2023

(30) Foreign Application Priority Data
Dec. 22, 2020 (DE) 10 2020 134 671.9

(51) Int. Cl. C23C 10/20

(52) U.S. Cl. CPC C23C 10/20

(57) ABSTRACT

The invention relates to a kit for preparing a chromium(VI)-free slurry suspension for diffusion coating of metal surfaces, the kit comprising, as separate components, a powder mixture and a liquid binder mixture, configured to be combined for preparing the slurry suspension, wherein the powder mixture comprises a powdered diffusion metal, wherein the binder mixture comprises an aqueous solvent and a phosphate binder, and wherein both the powder mixture and the binder mixture are free of chromium(VI) salts. The invention further relates to a method of diffusion coating a metal surface using such a kit, and to the use of such a kit in various industries.

The present application relates to a storable slurry composition for diffusion coating of metals.

Diffusion coating of metal components serves to protect the surface of the components against environmental influences, in particular against high-temperature corrosion. In diffusion coating, an oxide-forming diffusion metal is applied to the surface of the metal component and the surface is then heat-treated to facilitate diffusion of the diffusion metal into near-surface layers of the component material. Aluminum is the most commonly used oxide-forming diffusion metal in such applications, but depending on the substrate material, also other oxide-forming metals such as nickel, chromium, manganese, germanium, silicon, magnesium, tin, titanium and zinc, or corresponding metal alloys such as chromium-aluminum alloys or mixtures may be used. When using alloys or mixtures, several oxide formers are present in the diffusion layer.

There are various methods for applying the diffusion metal to the substrate surface. The most widely used are a so-called pack cementation method, in which the diffusion metal is deposited on the substrate surface from a gas phase, and a so-called slurry method.

The slurry method, which is the one of interest herein, comprises the application of a liquid suspension of a metal powder, possibly comprising a mixture of several metals or alloys, as diffusion metal and a binder, a so-called slurry, to the substrate surface. Application can be, for example, by means of brushing, spraying, dipping or film casting. The application is followed by a drying step to remove solvent from the suspension, and a thermal diffusion process. The slurry can be applied several times to achieve a certain dry film thickness.

The binder acts to fix the diffusion metal particles on the substrate after application of the slurry. Acidic phosphate binders containing chromium(VI) were frequently used in commercially available slurries. They form a polyphosphate network, in which the diffusion metal particles are immobilized on the substrate surface. Chromium(VI)-containing materials are advantageous because they passivate the oxidation-sensitive diffusion metal and possibly substrate surface and thus protect it from etching attack by the acidic phosphate binder, and because they promote formation of a ceramic-like and temperature-stable polyphosphate network on the substrate surface.

Due to their carcinogenic properties, however, the use of chromium(VI) salts should be avoided. Using other highly oxidized heavy metal salts as an alternative is likewise undesirable for occupational safety and environmental protection reasons.

Since in the absence of the chromium(VI) salts or comparable highly oxidized heavy metal salts, the acidic phosphate binder may attack the oxidation-sensitive diffusion metal and possibly substrate surface, various alternative formulations have been developed in the prior art. They comprise commercially available compositions based on organic polymer binders, but these show significant disadvantages compared to phosphate binders due to their lack of heat stability. The organic binders burn when exposed to heat, exposing the metal particles and causing them to evaporate or melt and run. Organic solvent-based systems are another known alternative, which is likewise linked to a number of problems. Specifically, in a multi-layer application they dissolve the lower layers and drying properties are suboptimal, such that they only allow for application of very thin layers and application has to be repeated often to achieve a reasonable layer thicknesses. In addition, organic solvents are undesirable for environmental protection and occupational safety reasons.

The problem to be solved by the invention is providing a slurry for diffusion coating, which fulfils health and environmental protection requirements and has excellent properties.

Against this background, the invention relates to a kit for the preparation of a chromium(IV)-free slurry suspension for the diffusion coating of metal surfaces, the kit comprising, as separate components, a powder mixture and a binder mixture, which are configured to be combined to prepare the slurry suspension, wherein the powder mixture comprises a diffusion metal powder, wherein the binder mixture comprises an aqueous solvent and a phosphate binder, and wherein both the powder mixture and the binder mixture are free of chromium(VI) salts.

Hence, the invention solves the technical problem by providing a system comprising at least two components, one component being a binder mixture, and the other component being a powder mixture adapted for a particular application.

To obtain the slurry suspension for application, the powder mixture and the binder mixture are mixed and homogenized. The resulting slurry suspension comprises the aqueous solvent and suspended diffusion metal powder and phosphate binder. It is free of chromium(VI) salts, which are classified as a Substance of Very High Concern (SVHC) under the REACH Regulation.

The product is provided as a multi-component system, in particular a two-component system, and is thus stable for storage despite the inherent reactivity of the acidic phosphate binder vis-á-vis oxidation-sensitive diffusion metal powders under chromium(VI)-free conditions. Hydrogen gas does not form and any explosion hazard is avoided.

The powder mixture is preferably a dry mixture, i.e., is preferably in the form of a dry powder. The binder mixture is a liquid mixture.

The ceramic layer formed by the phosphate binders immobilizes the diffusion metal particles on the substrate surface and is stable enough to withstand certain mechanical impact, for example during transport. This stands in contrast to prior art approaches using organic solvents or polymer binders, for example polyurethane binders, as explained further above. In the diffusion process, the glassy ceramic binder matrix causes molten metal not to run and form droplets or evaporate, thus reducing the risk of inhomogeneous film thicknesses. The glassy ceramic matrix also allows for an addition of catalysts, which, like the metals, are trapped during heating and do not evaporate immediately, but actually accelerate the reaction. The ceramic matrix ultimately becomes porous over depletion of the metal powders and can then be removed mechanically, for example by sandblasting, after the surface has cooled down. No chromium(VI)-containing dust is formed due to the absence of chromium(VI) salts.

The slurry suspension is water-based and free of volatile organic solvents, thus eliminating health and explosion hazards and a need for cumbersome precautions such as exhaust systems or forced-air ovens during drying. The water-based approach allows the slurry to air-dry quickly on the substrate surface without running. After drying or an initial low temperature baking, another layer can be applied to increase thickness of the coating. The ceramic structure formed by the phosphate binders is not changed or dissolved upon application of further layers and does not run. Since the drying behaviour is good, thicker coatings can be formed more quickly when compared to known solvent-based systems, such that layer thicknesses as required can be achieved with just two to four and, in particular, two to three iterations instead of, for example, seven iterations. This enables significant cost savings and throughput increase in coating formation.

The composition and pH of the binder mixture are such that no immediate etching of the diffusion metal powders, even after combination with the powder mixture.

Preferably, the pH of the binder mixture is pH 2.3 to pH 2.9, in particular pH 2.5 to pH 2.7. In this range, for example, finely divided aluminum powder is stable for several hours to days.

The solvent of the binder mixture is preferably pure water. Alternatively, aqueous solvents, for example aqueous alcohol mixtures with a water content of at least 50% by volume, preferably at least 80% by volume, can also be used.

The solvent or water content of the binder mixture is preferably 40 to 80 wt. %, measured against the total weight of the binder mixture. The solvent content does not only influence the reactivity of the binder mixture to the diffusion metal powders, but can be used to adjust the viscosity of the finished slurry.

The phosphate binder of the binder mixture comprises acidic monohydrogen or dihydrogen phosphates of cations such as aluminum, magnesium and/or zinc. It can be prepared from phosphoric acid and aluminum, magnesium and/or zinc salts or from raw materials such as Al(H₂PO₄)₃, Zn(H₂PO₄)₃ and Mg(H₂PO₄)₃. It is particularly preferred that the phosphate binder comprises proportions greater than 10-50%, or preferably 20-30%, of Al[H₂PO₄]₃. In an example, two or three different ones of the cations identified above may be present in the phosphate binder as counter-ions of the acidic phosphates. The cations stabilize the mixture against gel formation. The relative proportion of phosphoric acid, acidic monohydrogen or dihydrogen phosphates, and basic phosphate determines the pH.

The proportion of phosphate binder within the binder mixture, in terms of cumulative weight fractions of phosphoric acid or phosphoric acid anions without counter-ions, is preferably between 5 and 40%, further preferably between 10 and 30%.

The powder mixture can comprise powders of any metal suitable as a diffusion metal. Examples comprise aluminum as an oxide-forming diffusion metal, but depending on the substrate material, other oxide-forming metals such as aluminum, nickel, chromium, manganese, germanium, silicon, magnesium, tin, titanium or zinc, or alloys and mixtures thereof, can also be used. The composition of metals in the powder mixture shall be specifically adapted depending on the intended use.

Using untreated metal powders can be preferred. The 2-component-approach of the present invention enables a good shelf-life even without Cr(VI) and without expensive modification of the metal powders by methods like coating, for example. In the given context, untreated means that the metal powders are simply present as metal powders and have not undergone any treatment to, for example, coat them. An aluminum powder will, of course, have an oxide layer on the exposed surface, but this layer will have simply formed upon handling in air, without any special treatment. In embodiments of the invention, mixtures of aluminum powder and silicon powder can be used, and at least one and preferably all of the powder types in the mixture may be untreated.

Alternatively, coated powders can be used to further inhibit acidic attack, for example powders coated with silicon oxide SiOₓ (x=1-2).

To carry out an alumination, for example (whereby the term is used herein shall also encompass alonization and alitization), the powder mixture contains metallic aluminum powder, which can either be untreated or stabilized by a, for example, SiO₂ coating. The powder mixture may additionally contain metallic silicon powder. Mixtures of aluminum and silicon powders may be preferred in one embodiment.

To carry out a nickel alumination, compared to the mixture just described, a part of the aluminum powder can be replaced by nickel powder, or a powder of a nickel-aluminum alloy such as NiAl₃ or Ni—Al 95-5 can be used instead of or in addition to the aluminum powder.

To carry out a chromium alumination, compared to the mixture just described, a part of the aluminum powder can be replaced by chromium powder, or a powder of a chromium-aluminum alloy can be used instead of or in addition to the aluminum powder.

To carry out a chromation, the powder mixture contains metallic chromium powder, which can either be untreated or stabilized by, for example, an SiO₂ coating.

Preferably, the powder mixture comprises a catalyst, which can be water-insoluble and finely distributed in order to be enclosed in the binder matrix during heating like the metal powders, such as to not evaporate but actually accelerate the diffusion process. Preferably, the catalyst is a water-insoluble halogen salt of a metal that is used as a diffusion metal. Examples include AlF₃, AlF₃x3H₂O and CrCl₃, with AlF₃ or AlF₃x3H₂O for use in alumination or modified alumination, i.e. if at least some of the diffusion metal powder is aluminum or an aluminum-containing alloy, and with CrCl₃ for use in chromation or modified chromation, i.e. of at least some of the diffusion metal powder is chromium or a chromium-containing alloy.

In one embodiment, the powder mixture further comprises a preferably water-insoluble dye or pigment for coloring. Examples comprise blue cobalt alum inate spinel.

To increase corrosion resistance, the powder mixture can further comprise inert powders such as Al₂O₃

The binder mixture or powder mixture can further comprise an anti-settling agent, a thixotropic agent, a thickener, or mixtures thereof.

In use, a first step may comprise combining the powder mixture and the binder mixture and homogenizing the resulting mixture to obtain a slurry suspension. The slurry suspension can then be applied to the substrate surface, with precautions to avoid running. After air drying, another layer can be applied and again dried, to iteratively achieve sufficient green body thicknesses to obtain thick diffusion coatings.

Prior to the actual diffusion process, the coating can be treated for about 5-60 minutes, especially for 10-30 minutes at a temperature greater than 50° C., preferably 100° C. to 150° C. For example, a temperature of about 120° C. can be applied.

Depending on the substrate material and diffusion metal, the actual diffusion process is typically carried out at temperatures greater than 500° C., preferably between 880° C. to 1150° C., for a holding time of several hours. Process gases such as argon or hydrogen can advantageously be used at a low purge rate. To accelerate the diffusion reaction, catalysts such as those mentioned above, for example NH₄F, NH₄Cl, AlF₃ or AlF3X3H₂O can be added to the reactor.

Optionally, an endpoint for the reaction can be determined, for example by optical evaluation of transverse edges or EDX analysis in a scanning electron microscope.

Preferred applications of the kit according to the invention or the slurry suspensions generated therefrom include an application to metallic components for the aerospace industry, the energy industry, the automotive industry, the oil industry, the metal processing industry and the maritime industry, for increasing their corrosion resistance.

Further details and advantages of the invention will become apparent from the examples described in the following, with reference to the figures. The figures show:

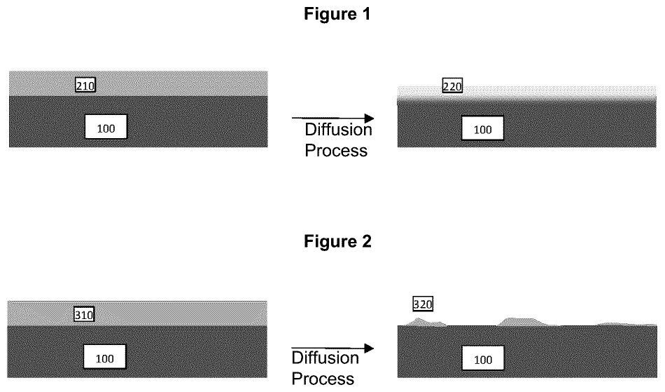

FIG. 1: a schematic representation of a surface alumination using a slurry suspension prepared with a kit according to the invention; and

FIG. 2: a schematic representation of a surface alumination using a Cr(VI)-free slurry suspension based on prior art organic binders.

### EXAMPLE 1: PREPARATION OF A LOW-VISCOSITY BINDER MIXTURE

In one embodiment, a low-viscosity binder mixture is obtained by mixing the following components.

| Component | Preferred range | | General range | |
|---|---|---|---|---|
| Water | 60-80 | wt. % | 50-90 | wt. % |
| Phosphoric acid | 15-30 | wt. % | 10-40 | wt. % |
| Aluminum hydroxide | 3-9 | wt. % | 1-10 | wt. % |
| Magnesium hydroxide | 1-3 | wt. % | 1-5 | wt. % |
| Zinc oxide | 1-4 | wt. % | 1-5 | wt. % |
| Additionally: LiOH, NaOH, KOH, | <1 | wt. % | <2 | wt. % |
| Ca(OH)₂, Ba(OH)₂ | | | | |

| | | |
|---|---|---|
| pH | 2.3-2.6 | 2.3-2.9 |

### EXAMPLE 2: PREPARATION OF A VISCOUS BINDER MIXTURE

In one embodiment, a viscous binder mixture is obtained by mixing the following components.

| Component | Preferred range | | General range | |
|---|---|---|---|---|
| Water | 40-60 | wt. % | 30-70 | wt. % |
| Phosphoric acid | 30-40 | wt. % | 20-50 | wt. % |
| Aluminum hydroxide | 5-15 | wt. % | 1-20 | wt. % |
| Magnesium hydroxide | 1-3 | wt. % | 1-5 | wt. % |
| Zinc oxide | 2-5 | wt. % | 1-5 | wt. % |
| Additionally: LiOH, NaOH, KOH, | <1 | wt. % | <2 | wt. % |
| Ca(OH)₂, Ba(OH)₂ | | | | |

| | | |
|---|---|---|
| pH | 2.3-2.6 | 2.3-2.9 |

### EXAMPLE 3: PREPARATION OF A POWDER MIXTURE FOR ALUMINATION

In one embodiment, a powder mixture for alumination is obtained by mixing the following components

| | | |
|---|---|---|
| Aluminum powder with/without SiO₂ | 80-100 | wt. % |
| Silicon powder | 0-15 | wt. % |
| AlF₃x3H₂O (as required)/AlF₃ | 0-5 | wt. % |

### EXAMPLE 4: PREPARATION OF A POWDER MIXTURE FOR CHROMATION

In one embodiment, a powder mixture for chromation is obtained by mixing the following components.

| | | |
|---|---|---|
| Chromium powder | 95-100 | wt. % |
| CrCl₃ | 0-5 | wt. % |

### EXAMPLE 5A: PREPARATION OF A POWDER MIXTURE FOR CHROMIUM ALUMINATION

In one embodiment, a powder mixture for chromium alumination is obtained by mixing the following components.

| | | |
|---|---|---|
| CrAl alloy e.g. CrAl 50/50 | 95-100 | wt. % |
| CrCl₃/AlF₃ x3H₂O/AlF₃ | 0-5 | wt. % |

### EXAMPLE 5B: PREPARATION OF A POWDER MIXTURE FOR CHROMIUM ALUMINATION

In one embodiment, an alternative powder mixture for chromium alumination is obtained by mixing the following components.

| | | |
|---|---|---|
| Chromium powder | 35-60 | wt. % |
| Aluminum powder | 35-60 | wt. % |
| CrCl₃/AlF₃ x3H₂O/AlF₃ | 0-5 | wt. % |

### EXAMPLE 6A: PREPARATION OF A POWDER MIXTURE FOR NICKEL ALUMINATION

In one embodiment, a powder mixture for nickel alumination is obtained by mixing the following components.

| | | |
|---|---|---|
| NiAl alloy e.g. NiAl 50/50 | 95-100 | wt. % |
| NiCl₃/AlF₃ x3H₂O/AlF₃ | 0-5 | wt. % |

### EXAMPLE 6B: PREPARATION OF A POWDER MIXTURE FOR NICKEL ALUMINATION

In one embodiment, an alternative powder mixture for nickel alumination is obtained by mixing the following components.

| | | |
|---|---|---|
| Nickel powder | 35-60 | wt. % |
| Aluminum powder | 35-60 | wt. % |
| NiCl₃/AlF₃ x3H₂O/AlF₃ | 0-5 | wt. % |

### EXAMPLE 7: SLURRY SUSPENSION FOR ALUMINATION

In one embodiment, a slurry suspension for alumination is obtained by mixing the following two components of a kit.

| Component | Preferred range | General range |
|---|---|---|
| Binder mixture Example 1 | 50-60 wt. % | 40-70 wt. % |
| Powder mixture Example 3 | 40-50 wt. % | 30-60 wt. % |

### EXAMPLE 8: SLURRY SUSPENSION FOR CHROMATION

In one embodiment, a slurry suspension for chromation is obtained by mixing the following two components of a kit.

| Component | Preferred range | General range |
|---|---|---|
| Binder mixture Example 2 | 40-50 wt. % | 30-60 wt. % |
| Powder mixture Example 4 | 50-60 wt. % | 40-70 wt. % |

### EXAMPLE 9: SLURRY SUSPENSION FOR CHROMIUM ALUMINATION

In one embodiment, a slurry suspension for chromium alumination is obtained by mixing the following two components of a kit.

| | |
|---|---|
| Binder mixture Example 2 | 40-50 wt. % |
| Powder mixture Example 5a or 5b | 50-60 wt. % |

### EXAMPLE 10: SLURRY SUSPENSION FOR NICKEL ALUMINATION

In one embodiment, a slurry suspension for nickel alumination is obtained by mixing the following two components of a kit.

| | |
|---|---|
| Binder mixture Example 2 | 40-50 wt. % |
| Powder mixture Example 6a or 6b | 50-60 wt. % |

### APPLICATION EXAMPLE 11: FORMATION OF A DIFFUSION LAYER (ALUMINATION)

The product of Example 7 is formed by preparing and then mixing the binder mixture and the powder mixture, by shaking or stirring.

The slurry suspension thus obtained is sprayed onto a degreased and corundum blasted (120 to 220 mesh) base material MAR M247 with a spray gun (nozzle diameter 0.8-1.0 mm; 1.5-2.0 bar) and dried. The process is repeated 1-2 times, depending on the intended layer thickness of the green body, and then treated at 120° C. for 30 min. Green layer thicknesses of 100-200 μm yield diffusion layer thicknesses of 30-80 μm.

Diffusion treatment is carried out in an oven under argon or hydrogen atmosphere at 880° C. and 4h holding time. After cool down, an ash layer can be removed by blasting with glass beads. Homogeneous diffusion layers with a thickness of 70 μm were obtained from green layers with 150 μm thickness.

The result is shown schematically in FIG. 1, where reference sign 100 denotes the base material, reference sign 210 denotes the green body and reference sign 220 denotes the diffusion layer.

Metallurgical analysis of a cross section by EDX in SEM showed a mass ratio of 25%/7% aluminum to silicium in the diffusion layer.

### COMPARATIVE EXAMPLE 12: FORMATION OF A DIFFUSION LAYER (ALUMINATION)

Prior art Cr(VI)-free slurry suspensions based on an organic binder do not typically yield homogeneous diffusion layers, but interrupted layers with defects like holes. In addition, depletion and the formation of droplets (aluminum beads) occurs. These effects are attributable to the absence of a phosphate matrix in the organic system.

FIG. 2 is a schematic illustration of such diffusion layers, with reference sign 100 denoting the base material, reference sign 310 denoting the green body and reference sign 320 denoting the droplets.

### APPLICATION EXAMPLE 13: FORMATION OF A DIFFUSION LAYER (CHROMATION)

The product of Example 8 is formed by preparing and then mixing the binder mixture and the powder mixture, by shaking or stirring.

The slurry suspension thus obtained is sprayed onto a degreased and corundum blasted (120 to 220 mesh) base material MAR M247 with a spray gun (nozzle diameter 0.8-1.0 mm; 1.5-2.0 bar) and dried. The process is repeated 1-2 times, depending on the intended layer thickness of the green body, and then treated at 120° C. for 30 min. Green layer thicknesses of 100-150 μm yield diffusion layer thicknesses of 30-70 μm.

Diffusion treatment is carried out in an oven under argon or hydrogen atmosphere at 1000-1150° C. and 4-10 hours holding time. The reaction rate and the final thickness of the diffusion layer can be significantly increased by adding catalysts such as NH₄Cl, NH₄F or AlF₃.

After cool down, an ash layer can be removed by blasting with glass beads.

Homogeneous diffusion layers with a thickness of 25 μm were obtained from green layers with 50 μm thickness.

Metallurgical analysis of a cross section by EDX in SEM showed an increase of chromium content in the diffusion layer up to 60-70%.

1. A kit for preparing a chromium(VI)-free slurry suspension for the diffusion coating of metal surfaces, the kit comprising, as separate components, a powder mixture and a liquid binder mixture, configured to be combined to obtain the slurry suspension, wherein the powder mixture comprises a diffusion metal powder, wherein the binder mixture comprises an aqueous solvent and a phosphate binder, and wherein both the powder mixture and the binder mixture are free of chromium(VI) salts.

2. The kit according to claim 1, wherein the kit is a two-component system, one component being the powder mixture and the other component being the binder mixture.

3. The kit according to claim 1, wherein the powder mixture is a dry powder.

4. The kit according to claim 1, wherein the pH of the binder mixture is pH 2.3 to pH 2.9.

5. The kit according to claim 1, wherein the solvent of the binder mixture is water or an aqueous solvent having a water content of at least 80% by volume, and/or in that the solvent content of the binder mixture, relative to its total weight, is from 40 to 80% by weight.

6. The kit according to claim 1, wherein the weight fraction of the phosphate binder in the binder mixture, as expressed by the cumulative weight of phosphoric acid and phosphoric acid anions without counter-ions, is between 5 and 25%.

7. The kit according to claim 1, wherein the phosphate binder contains hydrogen or dihydrogen phosphates of at least one cation of the group aluminum, zinc or magnesium.

8. The kit according to claim 1, wherein the diffusion metal is a metal selected from the group consisting of aluminum, silicium, nickel and chromium, or a metal alloy selected from the group consisting of aluminum-nickel and aluminum-chromium alloys.

9. The kit according to claim 1, wherein the diffusion metal of the powder mixture is untreated.

10. The kit according to claim 1, wherein the powder mixture comprises a water-insoluble catalyst contained as the diffusion metal.

11. The kit according to claim 1, wherein the powder mixture comprises a water-insoluble dye.

12. A method of diffusion coating a metal surface, comprising the steps of:
(i) combining the powder mixture and the binder mixture of a kit according to claim 1 to form a chromium(VI)-free slurry suspension;
(ii) applying the slurry suspension to the metal surface;
(iii) drying the applied slurry suspension by allowing the aqueous solvent of the binder mixture to evaporate, and to obtain a solid binder matrix on the metal surface, having particles of the diffusion metal powder dispersed therein; and
(iv) heating the binder matrix coated metal surface to temperatures of greater than 500° C.

13. The method according to claim 12, wherein steps (ii) and (iii) of application and drying are repeated several times, to obtain a multilayer binder matrix on the metal surface.

14. The method according to claim 12, wherein step (iii) of drying comprises treating for 10-30 minutes at a temperature greater than 50° C.

15. Use of a kit according to claim 1 in the aerospace industry, the energy industry, the automotive industry, the oil industry, the metalworking industry or the maritime industry.

16. The kit according to claim 1, wherein the pH of the binder mixture is pH 2.5 to pH 2.7.

17. The kit according to claim 1, wherein the weight fraction of the phosphate binder in the binder mixture, as expressed by the cumulative weight of phosphoric acid and phosphoric acid anions without counter-ions, is between 10 and 20%.

18. The kit according to claim 1, wherein the powder mixture comprises a halide of a metal contained as the diffusion metal.

19. The method according to claim 12, wherein steps (ii) and (iii) of application and drying are repeated two to four times, to obtain a multilayer binder matrix on the metal surface.

20. The method according to claim 12, wherein step (iii) of drying comprises treating for 10-30 minutes at a temperature from 100° C. to 150° C.
